(19) United States
(12) Patent Application Publication
(10) Pub. No.: US 2014/0248053 A1
(43) Pub. Date: Sep. 4, 2014

(54) OPTICAL NETWORK UNIT REGISTRATION METHOD AND OPTICAL NETWORK SYSTEM

(71) Applicant: OKI ELECTRIC INDUSTRY CO., LTD., TOKYO (JP)

(72) Inventor: Hideaki TAMAI, Tokyo (JP)

(73) Assignee: OKI ELECTRIC INDUSTRY CO., LTD., Tokyo (JP)

(21) Appl. No.: 14/167,440

(22) Filed: Jan. 29, 2014

(30) Foreign Application Priority Data
Mar. 1, 2013 (JP) 2013-040884

(51) Int. Cl. H04B 10/27

(52) U.S. Cl. CPC H04B 10/27
USPC 398/66

(57) ABSTRACT

An optical network unit registration method registers an unregistered optical network unit in a network that includes an optical line terminal having a plurality of optical subscriber units that allocate different wavelengths from one another, and a plurality of optical network units including a variable wavelength filter and configured to connect to the optical line terminal via one or more optical transmission paths. The optical network unit registration method includes a transmitting a wavelength notification signal that indicates a wavelength for the variable wavelength filter to one or more optical network units, a setting a transmission wavelength for the variable wavelength filter based on the wavelength that wavelength notification signal indicates, and a registering an unregistered optical network unit that receives the wavelength notification signal.

### CROSS-REFERENCE TO RELATED APPLICATION

This application claims priority under 35 U.S.C. §119 from Japanese Patent Application No. P 2013-040884, filed on Mar. 1, 2013, the disclosure of which is incorporated herein by reference.

### BACKGROUND OF THE INVENTION

1. Field of the Invention

The present invention relates to an optical network system and an optical network unit registration method in a network configured from a plurality of optical line terminals and one or more optical network units.

2. Description of Related Art

A communications network that links a building (e.g., station) owned by a communications operator and a subscriber's home is called an access network. In response to the increases in communication capacity of recent years, optical access networks that enable the transmission of very large amounts of information by utilizing optical communication are becoming mainstream.

One example of an optical access network is a passive optical network (PON). The PON is configured from one optical line terminal (OLT) provided in the station, one or more optical network units (ONU) respectively provided in subscribers' homes, and an optical splitter. The OLT, ONU(s), and the optical splitter are connected by the optical fiber.

A single optical fiber is used for the connection between the OLT and the splitter. This single optical fiber is shared by the ONU(s). Further, the optical splitter is a low-cost passive element. Thus, the PON(s) have excellent economic performance, and they are also easy to maintain. Consequently, the introduction of PON(s) is rapidly proceeding.

In a PON, the signals transmitted from the respective ONU(s) to the OLT (hereinafter, sometimes referred to as “uplink optical signal(s)”) are multiplexed by the optical splitter, and transmitted to the OLT. On the other hand, the signals transmitted from the OLT to the respective ONU(s) (hereinafter, sometimes referred to as “downlink optical signal(s)”) are demultiplexed by the optical splitter, and transmitted to the respective ONU(s). Further, to prevent interference between the uplink optical signals and the downlink optical signals, the uplink optical signals and the downlink optical signals are allocated respectively different wavelengths.

Further, in PON(s), various multiplexing technologies are used. Examples of multiplexing technologies that are used in PON(s) include time division multiplexing (TDM), in which short time divisions on the time axis are allocated to each subscriber, wavelength division multiplexing (WDM), in which different wavelengths are allocated to each subscriber, code division multiplexing (CDM), in which different codes are allocated to each subscriber and the like. Among these multiplexing technologies, a TDM-PON utilizing TDM is currently the most widely used. In the TDM-PON, TDMA (time division multiple access) is used. The TDMA is a technology in which the OLT controls so that uplink optical signals from different ONU(s) do not collide with each other by managing the transmission timing from each ONU.

A PON system that uses Ethernet® technology is called Ethernet®-PON, and a system that uses Gigabit (1*109 bit/sec) Ethernet® technology is called GE-PON. The GE-PON is standardized by the IEEE 802.3ah standard.

In a GE-PON system, to perform communication between the OLT and the ONU(s), the ONU(s) have to be registered in the OLT. Since the ONU(s) are connected, the registration of a new ONU needs to be performed without affecting communication between the other registered ONU(s) and the OLT. Consequently, the above-mentioned IEEE 802.3ah standard (hereinafter referred to as the “standard”) stipulates the procedure for detecting and registering an unregistered ONU by the OLT. The procedure is hereinafter referred to as a “discovery sequence.”

The OLT periodically broadcasts a discovery gate. A discovery gate is transmitted to all the ONU(s) regardless of whether the ONU is registered or not. When an ONU newly connected to the PON system is turned on and is capable of receiving signals, the ONU periodically receives a discovery gate. In this description, a discovery period means a period that the ONU transmits the discovery gates.

When the unregistered ONU receives the discovery gate, the ONU transmits a register request to the OLT to request registration. The register request includes a MAC address as an individual identification number of each ONU.

On the other hand, at the OLT, a discovery window is set. During the period that this discovery window is open, the OLT waits for reception of a register request.

When the OLT receives a register request, the OLT recognizes the MAC address of the ONU based on the register request. The OLT then transmits a register request response to the ONU that has the recognized MAC address. The register includes a link number (LLID) for the PON system.

After transmitting the register, the OLT notifies of the transmission band and the transmission timing of the ONU, and transmits a gate permitting transmission of uplink optical signals to the ONU.

When the ONU has received the gate, the ONU transmits a register acknowledgement (ACK) to the OLT. When the OLT receives the register acknowledgement, the registration for the ONU is complete. Namely, the discovery sequence is finished.

After the ONU is registered, normal communication between the OLT and the ONU is performed.

A PON system that uses TDM and WDM together has been proposed (hereinafter referred to as a “TDM/WDM-PON”). The OLT in the TDM/WDM-PON includes one or more OSU(s) (optical subscriber unit(s)).

In the TDM/WDM-PON, each OSU can communicate with ONU(s) by a set transmission wavelength of the downlink optical signals. And, the downlink optical signals and the uplink optical signals that are time division multiplexed are transmitted without interference for signals between the OSU(s) and ONU(s). In the TDM/WDM-PON, management for a plurality of ONU(s) is dealt with among the OSU(s). Thus, a number of the ONU(s) that are managed by one OSU may decrease, and the transmission band may be conserved.

In the TDM/WDM-PON, an ONU may be registered by one of the OSU(s). And, in the TDM/WDM-PON, the ONU may change wavelength of signals that the ONU transmits or receives.

Japanese patent publication 2011-4270 discloses that the ONU includes the variable wavelength filter in the TDM/WDM-PON.

In this system, an unregistered ONU waits for the discovery gate with sweeping a transmission wavelength for the variable wavelength filter. When the unregistered ONU receives the downlink optical signals, the unregistered ONU measures power of the downlink optical signals. As a result of the measurement, when the power of the downlink optical signals is smaller than a set value, the unregistered ONU sets the other transmission wavelength for the variable wavelength filter.

When the power of the downlink optical signals is larger than a set value, the unregistered ONU determines whether or not the downlink optical signals are the discovery gate. If the downlink optical signals are the discovery gate, the discovery sequence is performed. On the other hand, if the downlink optical signals are not the discovery gate, the unregistered ONU waits for the discovery gate for a set time. When the unregistered ONU does not receive the discovery gate while the unregistered ONU waits, the unregistered ONU again sets the other transmission wavelength for the variable wavelength filter.

In the TDM/WDM-PON, the unregistered ONU needs to keep changing transmission wavelengths for the variable wavelength filter until the unregistered ONU finishes receiving the discovery gate.

Besides, the set time while the unregistered ONU waits for the discovery gate is set longer than the discovery period, because the unregistered ONU needs to determine whether or not the discovery gate is received appropriately.

Thus, it takes much time to start the discovery sequence; in other words it takes much time to finish the discovery sequence.

### SUMMARY OF THE DISCLOSURE

An optical network unit registration method capable of finishing performing the discovery sequence faster than does the related art is disclosed.

According to one aspect, an optical network unit registration method for registers an unregistered optical network unit in a network. The network comprises an optical line terminal including a plurality of optical subscriber units that allocate a different wavelength from one another, and a plurality of optical network units including a variable wavelength filter and configured to connect to the optical line terminal via one or more optical transmission paths. The optical network unit registration method includes a transmission process transmitting a wavelength notification signal that indicates a wavelength for the variable wavelength filter to one or more optical network units, setting a transmission wavelength for the variable wavelength filter based on the wavelength that wavelength notification signal indicates, and registering an unregistered optical network unit that receives the wavelength notification signal.

### BRIEF DESCRIPTION OF THE DRAWINGS

The optical network unit registration method and the optical network system will be more fully understood from the following detailed description with reference to the accompanying drawings, which is given by way of illustration only, and is not intended to limit the scope of the invention, wherein:

FIG. 1 is a schematic configuration diagram of a TDM/WDM-PON;

FIG. 2 is a schematic configuration diagram of an OSU;

FIG. 3 is a schematic configuration diagram of an ONU;

FIG. 4 is a flowchart illustrating an optical network unit operation when an optical network unit is unregistered; and

FIG. 5 is a sequence diagram illustrating an optical network unit registration method.

### DETAILED DESCRIPTION OF THE INVENTION

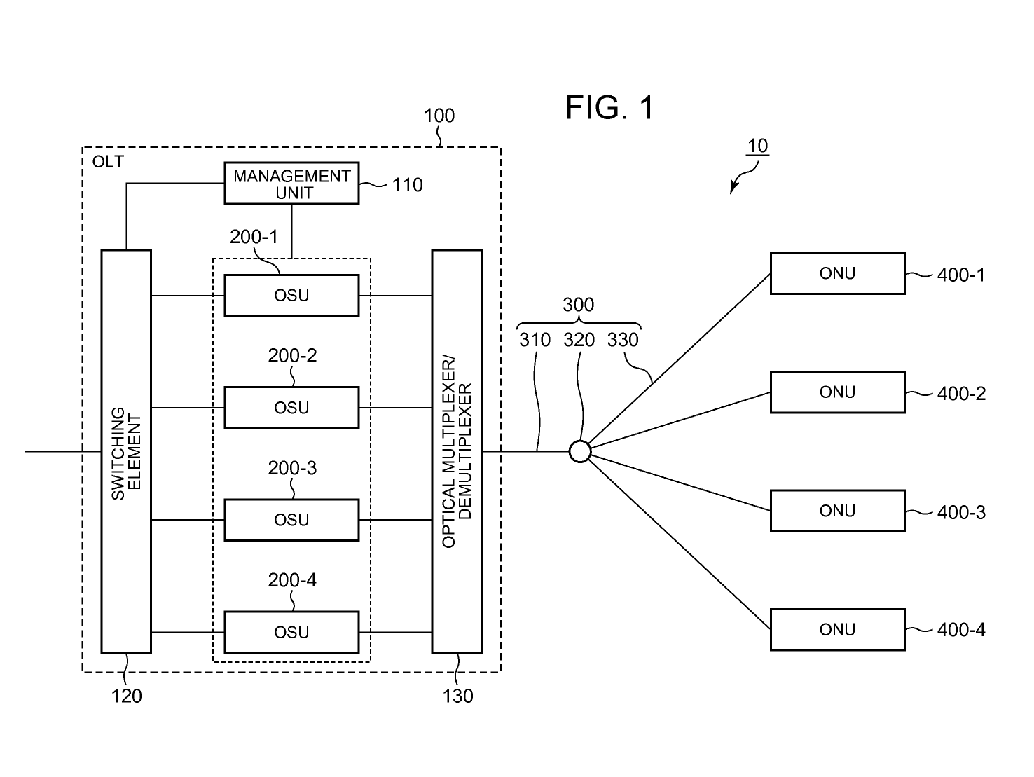

The optical network unit registration and the optical network system will be described with reference to FIGS. 1 to 5 of the drawings, in which like elements are indicated by like reference characters. In the drawings, configurations, positional relations, dimensions, and alignments of elements of the device are illustrated generally for understanding the embodiment and are only intended to provide an understanding of the invention. Described materials and numerical values are merely exemplary. In the drawings, common elements of structures may be designated by the same reference characters, and an explanation thereof is occasionally omitted. Accordingly, the invention is in no way limited to the following embodiment.

As shown in FIG. 1, a TDM/WDM-PON 10 includes an OLT 100 and one or more ONU(s) 400. The OLT 100 includes a switching element 120, one or more OSU(s) 200, and an optical multiplexer/demultiplexer 130.

The optical transmission path 300 includes an optical fiber 310, an optical splitter 320, and a plurality of optical fibers 330. The optical fiber 310 connects the optical multiplexer/demultiplexer 130 to the optical splitter 320. The optical fiber 310 branches optical fibers 330 that connect the ONU(s) 400.

The ONU(s) 400 generate uplink optical signals that include an uplink data signal received from a user terminal and an uplink control signal for requesting bandwidth, and the ONU(s) 400 transmit the generated signals to the OLT(s) 100.

The OSU(s) 200 generate downlink optical signals that include a downlink data signal that the OSU(s) 200 receive from a higher network and a downlink control signal for managing the ONU(s) 400, and transmit the generated downlink optical signals to the ONU(s) 400.

As shown in FIG. 1, the TDM/WDM-PON 10 includes the four OSU(s) 200-1 to 200-4 and the four ONU(s) 400-1 to 400-4. However, the number of OSU(s) 200 and ONU(s) 400 is not limited.

One of the OSU(s) 200 may register the ONU 400 in the TDM/WDM-PON 10.

The OSU(s) 200 are allocated respectively different wavelengths. The OSU(s) 200 transmit downlink optical signals whose wavelength has been allocated, and receive uplink optical signals whose wavelength has been allocated.

The ONU 400 transmits uplink optical signals whose wavelength is allocated for the OSU 200. To avoid interference among uplink optical signals from the ONU(s) 400, the ONU 400 transmits uplink optical signals at different timing among the ONU(s) 400 that are registered by an OSU 200. The OSU 200 informs the ONU(s) 400 about a transmission wavelength of the uplink optical signals and transmission timing that the ONU 400 uses when transmitting uplink optical signals.

The management unit 110 manages PON link information about the OSU(s) 200 to which ONU(s) 400 belong and ONU(s) 400 for which a PON link has been established. The management unit 110 stores the PON link information in a storage unit (not illustrated), such as a RAM (random access memory), in a readable/writable manner. The management unit 110 makes a transmission plan based on addresses for downlink data and network traffic information between the OSU 200 and the ONU 400 from the switching element 120, and the PON link information. The management unit 110 informs the switching element 120 and the OSU(s) 200 about the transmission plan.

The management unit 110 may generate wavelength setting signals that set wavelengths of the downlink optical signals for each OSU(s) 200, and the wavelength setting signals are sent to the OSU 200. In the TDM/WDM-PON 10, each OSU 200 communicates with ONU(s) by a set transmission wavelength of the downlink optical signals. Thus, the management unit 110 may set a unique wavelength of the downlink optical signals for each OSU 200.

The management unit 110 recognizes OSU(s) 200 that perform the discovery sequence. Next, the management unit 110 directs each OSU(s) 200 that performs the discovery sequence to generate a wavelength notification signal based on the wavelength setting signal.

The switching element 120 sets communication paths between an upper network that is connected to the switching element 120 and OSU(s) 200. The switching element 120 allocates downlink data signals to the respective OSU(s) 200 based on the transmission plan that the management unit 110 has made, and transmits uplink data signals that the OSU(s) 200 have sent to the upper network. The switching element 120 transmits information from the upper network, for example addresses for downlink data signals and the network traffic information, to the management unit 110.

The optical multiplexer/demultiplexer 130 multiplexes downlink optical signals whose each wavelength are unique from each OSU 200, and transmits the multiplexed downlink optical signals to the ONU 400 via the optical transmission path 300. The optical multiplexer/demultiplexer 130 demultiplexes uplink optical signals by wavelength, and transmits the demultiplexed uplink optical signals to the OSU 200 whose allocated wavelength corresponds to the uplink optical signal.

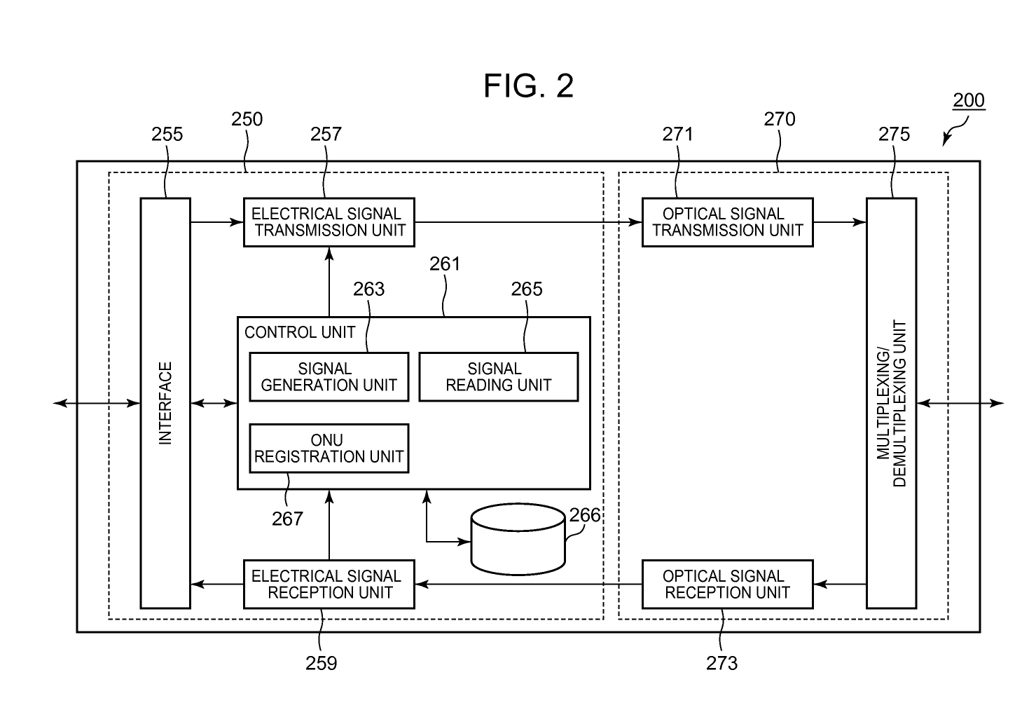

As shown in FIG. 2, the OSU 200 includes an electrical signal processing unit 250 and an optical signal processing unit 270. The electrical signal processing unit 250 includes an interface 255, an electrical signal transmission unit 257, an electrical signal reception unit 259, and a control unit 261. The optical signal processing unit 270 includes an optical signal transmission unit 271, an optical signal reception unit 273, and a multiplexing/demultiplexing unit 275.

Since the interface 255, the electrical signal transmission unit 257, and the electrical signal reception unit 259 can be configured in the same manner as an arbitrary suitable related-art OSU or OLT, a detailed description thereof will be omitted here.

The interface 255 transmits and receives uplink data signals and downlink data signals to/from an upper network via the switching element 120.

The electrical signal transmission unit 257 generates a downlink electrical signal based on a downlink data signal that the electrical signal transmission unit 257 has received from the interface 255 and a downlink control signal that the electrical signal transmission unit 257 has received from the control unit 261. The downlink electrical signal is transmitted to the optical signal transmission unit 271.

The electrical signal reception unit 259 separates the uplink electrical signal that the electrical signal reception unit 259 has received from the optical signal reception unit 273 into an uplink data signal and an uplink control signal. The uplink data signal is transmitted to an upper network via the interface 255 and the switching element 120. The uplink control signal is transmitted to the control unit 261.

The control unit 261 includes, as functional units, a signal generation unit 263, a signal reading unit 265, computer-readable storage media 266, and an ONU registration unit 267. The control unit 261 can be configured in the same manner as a related-art OLT or OSU. Each of these functional units and others of the units described herein may be realized by a program or programs comprising computer-executable instructions stored in computer-readable storage media 266 and executed by the control unit 261 or other processors and/or computing devices to effect the operations described herein. Additionally or alternatively, operations described herein may be implemented by application-specific circuits, for example. Further, the processing results and the like of each functional unit are appropriately stored in computer-readable storage media 266, such as a RAM or HDD.

The signal generation unit 263 generates a downlink control signal. For example, downlink control signals include a signal setting an uplink optical signal transmission wavelength for an ONU 400, the transmission timing, and the discovery gate that is used in the discovery sequence and the like. The uplink optical signal transmission band to an ONU 400 and the transmission timing are based on the transmission plan that the signal generation unit 263 has received from the management unit 110 and the required bandwidth that the signal generation unit 263 has received from the ONU 400. The downlink control signal includes a wavelength notification signal. The wavelength notification signal is generated based on the notification from the management unit 110. The wavelength notification signal is a signal that notifies the ONU 400 of a wavelength of a downlink optical signal for the OSU 200 that performs the discovery sequence. The downlink control signal also includes information concerning the transmission wavelength of the uplink optical signal. The downlink control signal is transmitted to the electrical signal transmission unit 257.

The signal reading unit 265 reads information about each ONU that is included in the uplink control signal; for example, the information includes a MAC address or required bandwidth.

The ONU registration unit 267 registers an ONU 400 which a PON link is established for. Further, the ONU registration unit 267 notifies the management unit 130 via the interface 255 of the PON link information indicating with which OSU 200 an ONU(s) 400 has established a PON link.

The optical signal transmission unit 271 converts a downlink electrical signal into a downlink optical signal. The optical signal transmission unit 271 has an arbitrary suitable electrical/optical conversion unit capable of changing wavelength, such as a TLD (tunable laser diode). The optical signal transmission unit 271 sets a wavelength of the downlink optical signal based on a wavelength setting signal that is transmitted from the management unit 130. The downlink optical signal is transmitted to the multiplexing/demultiplexing unit 275 via the optical multiplexer/demultiplexer 130.

The optical signal reception unit 273 converts an uplink optical signal that is transmitted via the multiplexing/demultiplexing unit 275 into an uplink electrical signal. The optical signal reception unit 273 includes an arbitrary suitable photoelectric conversion element, for example a PD (photo diode). The PD is set so that it can at least receive uplink optical signals in a wavelength band that can be set by the ONU(s) 400. The uplink electrical signals are transmitted to the electrical signal reception unit 259.

The multiplexing/demultiplexing unit 275 transmits downlink optical signals that are generated by the optical signal transmission unit 271 to the optical multiplexer/demultiplexer 130, and transmits uplink optical signals that are transmitted from the optical multiplexer/demultiplexer 130 to the optical signal reception unit 273. The multiplexing/demultiplexing unit 275 includes an arbitrary suitable multiplexer/demultiplexer, for example a WDM filter. As already described above, the downlink optical signals use light in different wavebands from the light used for the uplink optical signals. Consequently, by utilizing a WDN filter for example, uplink optical signals and downlink optical signals can be multiplexed and demultiplexed.

A route for downlink optical signals from the OSU 200 to ONU 400 is described below.

The downlink data signal that is transmitted from the upper network is transmitted to the switching element 120. The switching element 120 recognizes the transmission plan and address for destination that are made by the management unit 110, and transmits the downlink data signal to the OSU 200 according to the transmission plan and address. The OSU 200 recognizes a wavelength based on the wavelength setting signal that is generated by the management unit 110, and converts a downlink data signal that is transmitted from the switching element 120 into a downlink optical signal having the wavelength. The downlink optical signal is transmitted to the ONU 400 via the optical transmission path 300.

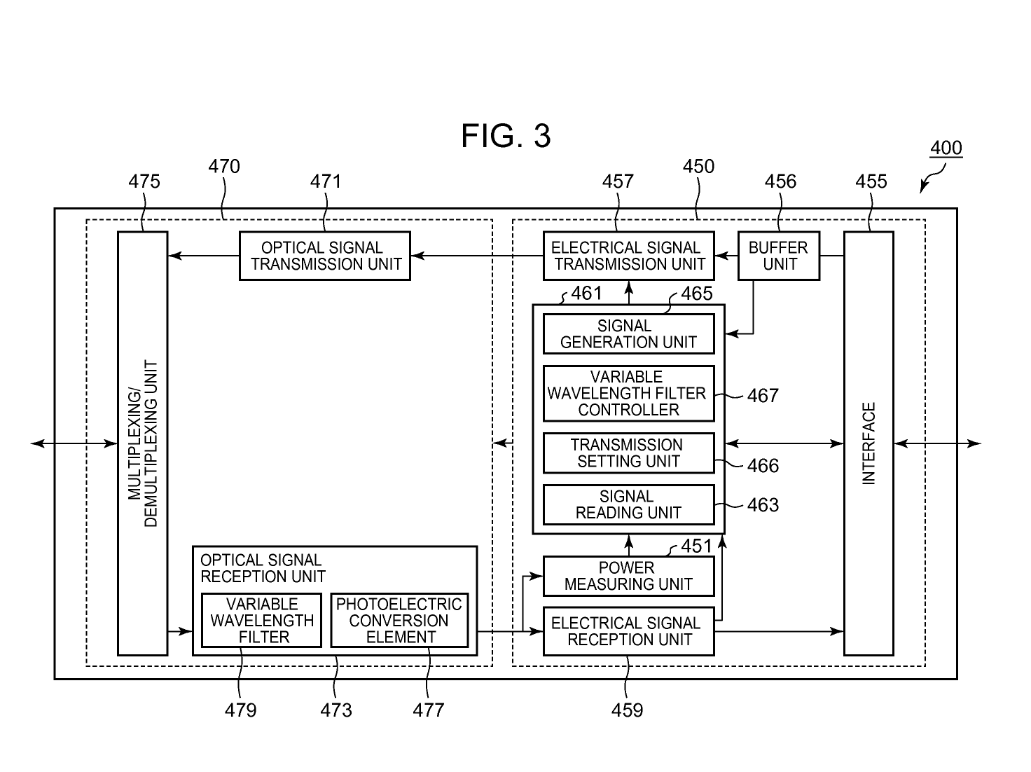

As illustrated in FIG. 3, the ONU(s) 400 include an electrical signal processing unit 450 and an optical signal processing unit 470.

The electrical signal processing unit 450 includes an interface 455, a buffer unit 456, an electrical signal transmission unit 457, an electrical signal reception unit 459, a power measuring unit 451, and a control unit 461. The optical signal processing unit 470 includes an optical signal transmission unit 471, an optical signal reception unit 473, and a multiplexing/demultiplexing unit 475.

Since the interface 455, the buffer unit 456, the electrical signal transmission unit 457, and the electrical signal reception unit 459 can be configured in the same manner as an arbitrary suitable related-art ONU, a detailed description thereof will be omitted here.

The interface 455 transmits and receives uplink optical signals and downlink optical signals to/from a user terminal.

The buffer 456 stores uplink optical signals transmitted from the interface 455. The buffer 456 notifies the control unit 461 of the stored data amount (buffer amount), reads an uplink data signal in response to an instruction from the control unit 461, and transmits the uplink data signal that is read to the electrical signal transmission unit 457.

The electrical signal transmission unit 457 generates an uplink electrical signal based on the uplink data signal that is received from the buffer 456 and the uplink control signal that is received from the control unit 461. Next, the electrical signal transmission unit 457 transmits the uplink electrical signal to the optical signal transmission unit 471.

The electrical signal reception unit 459 separates the downlink electrical signal into a downlink data signal and a downlink control signal. The downlink data signal is transmitted to the user terminal via the interface 455. The downlink control signal is transmitted to the control unit 461.

The power measuring unit 451 measures a power of light of a downlink optical signal based on the downlink electrical signal that is transferred from the optical signal reception unit 473. The power measuring unit 451 notifies the control unit 461 of information about a result of the measuring.

The control unit 461 includes a signal reading unit 463, a signal generation unit 465, a transmission setting unit 466, and a variable wavelength filter controller 467.

The signal reading unit 463 reads the information that may be necessary to perform communication with an OLT, such as information that indicates the transmission bandwidth for the uplink optical signal, the transmission timing, and the transmission wavelength, that is included in the downlink control signal. In addition, the signal reading unit 463 reads the wavelength notification signal that indicates the wavelength for the downlink optical signal that the OSU 200 has set. The wavelength notification signal may be in or part of the downlink control signal.

The signal generation unit 465 generates an uplink control signal that notifies an OSU 200 of the buffer amount that is read from the buffer unit 456. The uplink control signal is transmitted to the electrical signal transmission unit 457.

The transmission setting unit 466 notifies the optical signal transmission unit 471 of, for example, the wavelength for the uplink optical signal, the transmission timing, and the wavelength for the downlink optical signal to notify the ONU(s) 400 that are read by the signal reading unit 463.

The variable wavelength filter controller 467 notifies a variable wavelength filter 479 of a wavelength that the variable wavelength filter 479 is to be set at based on the power of light that is measured by the power measuring unit 451 or the wavelength information that is included in the wavelength notification signal.

The optical signal transmission unit 471 converts the uplink electrical signal into an uplink optical signal. The optical signal transmission unit 471 has an arbitrary suitable electrical/optical conversion unit capable of changing the wavelength, such as a TLD (tunable laser). The uplink optical signal is set based on a notification from the transmission setting unit 466. The uplink optical signal that has been generated by the optical signal transmission unit 471 is transmitted via the multiplexing/demultiplexing unit 475 to the OSU 200.

The optical signal reception unit 473 converts the downlink optical signal that is transmitted via the multiplexing/demultiplexing unit 475 into a downlink electrical signal. The downlink electrical signal is transmitted to the electrical signal reception unit 459. The optical signal reception unit 473 includes an arbitrary suitable photoelectric conversion element 477, such as a PD (photodiode), for example. The PD is set so that it can at least receive downlink optical signals in a wavelength band that can be set by the OSU 200.

The variable wavelength filter 479 sets a transmission wavelength according to the notice from the variable wavelength filter controller 467.

The multiplexing/demultiplexing unit 475 multiplexes/demultiplexes uplink optical signals and downlink optical signals. The multiplexing/demultiplexing unit 475 includes an arbitrary suitable multiplexer/demultiplexer, such as a WDM filter, for example. As already described above, the uplink optical signals and the downlink optical signals are allocated respectively different wavelengths. Thus, for example, the WDM filter is applied for the multiplexing/demultiplexing unit 475 to multiplex/demultiplex uplink optical signals and downlink optical signals.

Next, the path of an uplink optical signal from an ONU 400 to an OSU 200 will be described.

An uplink data signal from a user terminal is transmitted to an ONU 400. The ONU 400 converts the received uplink data signal into an uplink optical signal based on the transmission bandwidth for the uplink optical signal, the transmission timing, and the transmission wavelength that are included in the downlink control signal. The uplink optical signal is transmitted to an OSU 200.

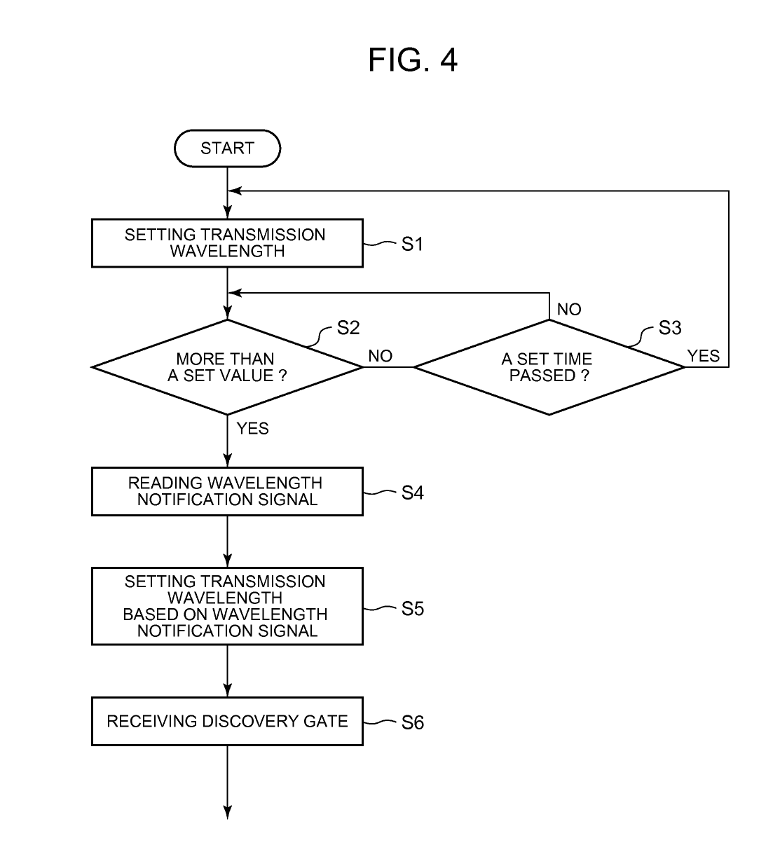

Operations of the unregistered ONU 400 will now be described with reference to FIG. 4. Here, a case is described wherein the unregistered ONU 400 is registered by the above-described standard discovery sequence.

A discovery sequence is performed when, for example, an unregistered ONU 400 is connected to the network and started up. Further, when rebooting an already-registered ONU 400, this registered ONU become unregistered, and is thus re-registered according to the discovery sequence.

The unregistered ONU 400 sets a transmission wavelength of the variable wavelength filter 479 based on the notice from the variable wavelength filter controller 467 (S1).

Next, the unregistered ONU400 determines whether or not the power of the downlink optical signals is more than a set value (S2).

The downlink optical signal is transmitted to the optical signal reception unit 473 via the multiplexing/demultiplexing unit 475. The optical signal reception unit 473 converts the downlink optical signal into a downlink electrical signal. The electrical signal reception unit 459 separates the downlink electrical signal into a downlink data signal and a downlink control signal, and the electrical signal reception unit 459 transmits the downlink control signal to the control unit 461. The power measuring unit 451 measures a power of light of a downlink optical signal based on the downlink electrical signal. The power measuring unit 451 notifies the control unit 461 of information about a result of the measuring. The control unit 461 determines whether or not the power that is indicated in the result is more than a set value.

If the power of the optical signal is larger than the set value (Yes), S4 is performed.

If the power of the optical signal is smaller than the set value (No), S3 is performed. The unregistered ONU 400 waits for a while until it receives a downlink optical signal having a power that is larger than the set value.

The control unit 461 determines whether or not a set time has passed (S3). If the set time has passed (S3, Yes), the unregistered ONU400 sets the other transmission wavelength for the variable wavelength filter (S1). If the set time has not passed (S3, No), the control unit 461 determines whether or not a downlink optical having a power that is larger than the set value is transmitted (S2).

As shown in FIG. 1, the TDM/WDM-PON 10 includes the OSU 400-1 to 400-4. The OSU 400-1 to 400-4 are allocated respectively, for example, lambda 1 to 4 as transmission wavelengths by the management unit 110. As described above, while the OSU 400 performs S1 to S3 until a power of the downlink optical signal is larger than the set value in S3, a transmission wavelength for the variable wavelength filter 479 is changed, for example, lambda 1 to 4 serially at set intervals. When a power of the downlink optical signal is larger than the set value, the wavelength that the OSU 400 has received is the transmission wavelength for which the variable wavelength filter 479 is to be set. The set time that the OSU 400 waits for the downlink optical signal whose power is larger than the set value may be longer than the discovery period.

The control unit 461 reads a wavelength notification signal that is periodically included in downlink control signal with the signal reading unit 463 (S4).

The wavelength notification signal notifies the ONU 400 of a wavelength that the ONU 400 is to set. Information that is included in the wavelength notification signal is read by the signal reading unit 463, and transferred to the variable wavelength filter 479 by the variable wavelength filter controller 467.

The variable wavelength filter 479 sets the transmission wavelength based on the wavelength that is included in the wavelength notification signal (S5).

As described above, the wavelength that the wavelength notification signal notifies of is a wavelength of a downlink optical signal for which the OSU 200 performs the discovery sequence. Thus, the transmission wavelength corresponds to a wavelength of a response request signal, for example, the discovery gate.

Next, the ONU 400 receives the discovery gate (S6).

In S5, the transmission wavelength for the variable wavelength filter 479 has been set corresponding to the wavelength of the discovery gate. Thus, the ONU 400 receives the discovery gate whose optical power is larger than the set value.

After the ONU 400 receives the discovery gate, the discovery sequence is performed between the ONU 400 and the OSU 200 that sends the discovery gate.

When a downlink optical signal that the ONU 400 receives includes the discovery gate and optical power of the downlink optical signal is larger than a set value (S2), the discovery sequence is performed without S4 to S6.

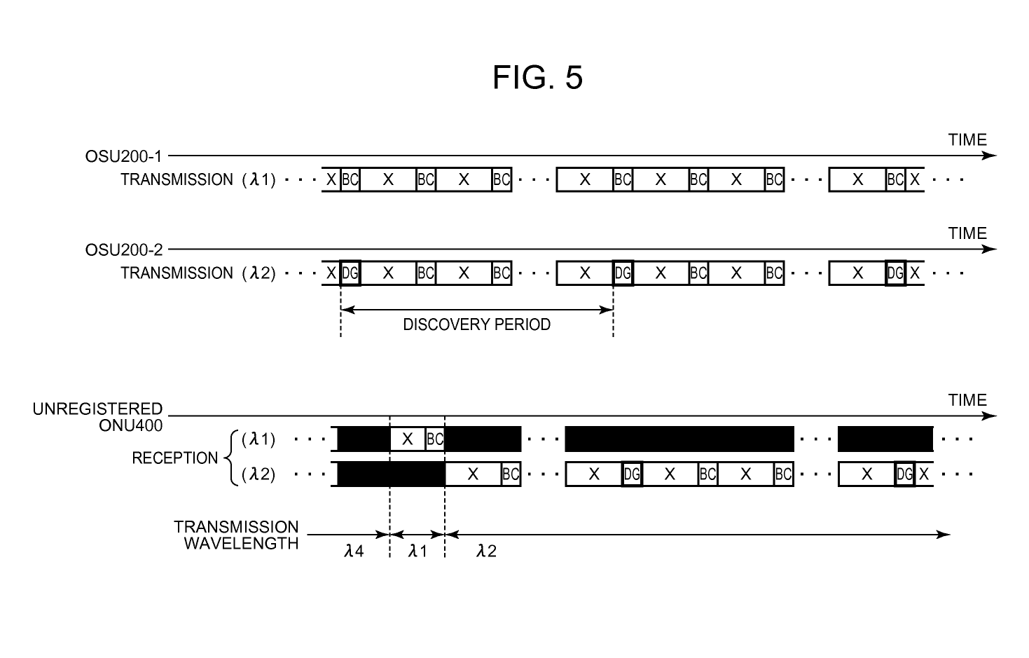

The optical network unit registration method will now be described with reference to FIG. 5. Here, a case is described in which the optical network unit registration method is applied in the above-described standard discovery sequence. In this case, the OSU 200-1 and 200-2 works, and the OSU 200-2 performs the discovery sequence. The OSU 200-1 transmits downlink optical signals of a wavelength lambda 1, and the OSU 200-2 transmits downlink optical signals of a wavelength lambda 2.

The OSU 200-1 periodically transmits downlink optical signals that include the wavelength notification signal. The period of time to transmit the wavelength notification signal is shorter than the discovery period. In FIG. 5, BC indicates the wavelength notification signal, DG indicates the discovery gate, and X indicates the other signals.

The wavelength notification signal is generated as part of the downlink control signal by the signal generation unit 263. As described above, the wavelength notification signal has information that notifies an unregistered ONU 400 of a wavelength of downlink optical signal that the unregistered ONU 400 is to set. The wavelength notification signal is generated to notify an unregistered ONU 400 of a wavelength lambda 2 of downlink optical signal. The downlink control signal that includes the wavelength notification signal is transmitted to the electrical signal transmission unit 257. The electrical signal transmission unit 257 generates a downlink electrical signal based on a downlink data signal that the electrical signal transmission unit 257 has received from the interface 255 and the downlink control signal. The downlink electrical signal is converted into a downlink optical signal by the optical signal transmission unit 271, and the downlink optical signal is transmitted to the ONU 400 via the multiplexing/demultiplexing unit 275, the optical multiplexer/demultiplexer 130, and the optical transmission path 300. The downlink optical signal that includes the wavelength notification signal is transmitted to all of the ONUs 400; for example, the transmitted wavelength notification signal is broadcast. A registered ONU 400 does not change its transmission wavelength even though it receives the wavelength notification signal.

The OSU 200-2 transmits a discovery gate to the respective ONU 400.

The discovery gate is generated as a downlink control signal by the signal generation unit 263. This downlink control signal includes information indicating the transmission timing and the transmission wavelength to be used for the response signal (here, a register request) to the ONU(s) 400. The downlink control signal is converted into a downlink optical signal by the electrical signal transmission unit 257 and the optical signal transmission unit 271, and is then transmitted to the respective ONU 400.

When the OSU 200-2 communicates with a registered ONU 400, the OSU 200-2 also transmits a downlink optical signal that includes the wavelength notification signal.

The unregistered ONU 400 waits for a downlink optical signal with sweeping transmission wavelength for the variable wavelength filter 479. When the unregistered ONU 400 does not receive any downlink optical signal until a set time has passed, the wavelength lambda 1, 2, 3, or 4 is respectively changed to be the transmission wavelength.

When the transmission wavelength is the wavelength lambda 3 or 4 and the ONU 400 receives a downlink optical signal from the OSU 200-1 that is wavelength lambda 1 or a downlink optical signal from the OSU 200-2 that is wavelength lambda 2, the control unit 461 in the ONU 400 determines that optical power of the downlink optical signal is smaller than a set value (FIG. 4, S2). Thus, the transmission wavelength is changed (FIG. 4, S1). Here, the transmission wavelength is changed from the wavelength lambda 4 to the wavelength lambda 1. In FIG. 5, the term during which the optical power is smaller than the set value is illustrated by black.

Next, the unregistered ONU 400 that is set the wavelength lambda 1 for the transmission wavelength receives a downlink optical signal from the OSU 200-1 that is the wavelength lambda 1. The control unit 461 determines optical power of the downlink optical signal is larger than a set value (FIG. 4, S2). The downlink optical signal from the OSU 200-1 includes the wavelength notification signal. The signal reading unit 463 reads information in the wavelength notification signal, and the variable wavelength filter controller 467 notifies a variable wavelength filter 479 of a wavelength that the variable wavelength filter 479 is set (FIG. 4, S4). The transmission wavelength for the variable wavelength filter 479 is set the wavelength that is notified by the variable wavelength filter controller 467 (FIG. 4, S5). Here, the variable wavelength filter controller 467 notifies a variable wavelength filter 479 of a wavelength lambda 2. Thus, the transmission wavelength for the variable wavelength filter 479 is changed from the wavelength lambda 1 to the wavelength lambda 2 (FIG. 5).

Next, the unregistered ONU 400 receives a downlink optical signal as the discovery gate that is transmitted by the OSU 200-2.

The downlink optical signal as the discovery gate is transmitted to the optical signal reception unit 473 via the multiplexing/demultiplexing unit 475. The downlink optical signal is converted into a downlink control signal by the optical signal reception unit 473 and the electrical signal reception unit 459. The downlink control signal is transmitted to the power measuring unit 451. The power measuring unit 451 measures a power of light as a downlink optical signal based on the downlink control signal. The power measuring unit 451 notifies the control unit 461 of information about a result of the measuring, and the downlink control signal is transmitted to the control unit 461. The transmission wavelength for the variable wavelength filter 479 is set to the wavelength lambda 2 that is the wavelength of the OSU 200-2. Thus, the control unit 461 determines that the optical power of the downlink optical signal as the discovery gate is larger than a set value. Next, the signal reading unit 463 reads information indicating the transmission timing and the transmission wavelength of the register request, and the control unit 461 adds random delay and the transmission timing. The control unit 461 notifies the optical signal transmission unit 471 of a transmission timing with the added random delay and the transmission wavelength that is read by the signal reading unit 463. The transmission wavelength of the register request is set to a wavelength for the OSU 200-2 that is the source of the discovery gate.

Next, the unregistered ONU 400 transmits a register request requesting registration to the OSU 200-2 as a response to the discovery gate.

The control unit 461 generates a register request with the signal generation unit 465. The register request includes a MAC address as an ONU 400 individual identification number. An uplink control signal is transmitted to the electrical signal transmission unit 457. The electrical signal transmission unit 457 generates an uplink electrical signal based on the uplink control signal, and transmits the uplink electrical signal that has been generated to the optical signal transmission unit 471. The optical signal transmission unit 471 converts the uplink electrical signal into an uplink optical signal. The uplink optical signal is generated based on the transmission wavelength that is sent from the control unit 461. The uplink optical signal is transmitted from the optical signal transmission unit 471 at the transmission timing that is determined by the control unit 461. The uplink optical signal is transmitted to the OSU 200-2 via the multiplexing/demultiplexing unit 475 and the optical multiplexer/demultiplexer 130.

The OSU 200-2 receives the register request that is transmitted by the unregistered ONU 400.

A discovery window is set in the OSU 200-2. During the period that this discovery window is open, the OSU 200-2 waits for reception of a register request from the ONU(s) 400. Further, the magnitude of a random delay set by the ONU(s) 400 is set so that reception of the register request by the OSU 200-2 is within the range that the discovery window is open.

At the OSU 200-2, an uplink optical signal as a register request is transmitted to the optical signal reception unit 273 via the multiplexing/demultiplexing unit 275. The optical signal reception unit 273 converts the uplink optical signal into an uplink electrical signal. The uplink electrical signal that has been converted is transmitted to the electrical signal reception unit 259. The electrical signal reception unit 259 restores the uplink electrical signal into an uplink control signal. The restored uplink control signal is transmitted to the control unit 261. The control unit 261 reads the MAC address that is included in the uplink control signal with the signal reading unit 265.

Next, the OSU 200-2 notifies the ONU 400 that has the above-described MAC address of the register signal that includes an LLID, the transmission bandwidth, and the transmission timing, and sequentially transmits a gate that permits uplink optical signal transmission. The ONU 400 that has received the gate transmits a register acknowledgement to the OSU 200-2. When the OSU 200-2 receives the register acknowledgement, the registration of the ONU 400 in the OSU 200-2 is complete.

After the discovery sequence is finished, the ONU registration unit 267 of the control unit 261 registers the ONU 400 that is registered in that discovery sequence. In other words, the ONU registration unit 267 registers the ONU 400 for which a PON link has been newly established. Then, the ONU registration unit 267 transmits the registered information to the management unit 110.

The discovery sequence is performed periodically.

Thus, in the above-described optical network unit registration method, the OSU 200 that communicates normally broadcasts a downlink optical signal that includes the wavelength notification signal and is transmitted normally. As described above, the period of time to transmit the wavelength notification signal is shorter than the discovery period. When the OSU 400 changes a transmission wavelength for the variable wavelength filter 479 based on the wavelength notification signal, the ONU 400 receives downlink optical signals that are involved in the performance of the discovery sequence between the OSU 200 and the ONU 400. Thus, the discovery sequence may be performed without changing for the transmission wavelength multiple times.

Here, this optical network unit registration method is not limited to the example described above.

A discovery sequence between OSUs 200 and the ONU 400 may be performed. In this case, the OSU 200-1 and 200-2 work, and the OSU 200-1 and 200-2 perform a discovery sequence. Because operations in this optical network unit registration method are substantially the same as with the above-described optical network unit registration method, a detailed description will be omitted here.

When the OSUs 200 perform the discovery sequence, the wavelength notification signal that each the OSUs 200 send includes more than two wavelengths that the ONU 400 sets one of them.

When the OSU 200-1 and the OSU 200-2 perform the discovery sequence, the wavelength notification signal notifies the ONU 400 of wavelength lambda 1 and wavelength lambda 2 that the ONU 400 sets. The management unit 110 determines wavelengths which the wavelength notification signal notifies of.

The wavelength notification signal includes a wavelength priority that corresponds to the wavelengths that are the subject of notification to the ONU 400. The wavelength priority is determined based on, for example a number of registered ONU(s) 400 under the OSU 200 that perform the discovery sequence. In the TDM/WDM-PON, it is preferred that the number of registered ONU(s) 400 which one OSU 200 manages is small, because under that condition the ONU 400 can communicate with OSU 200 effectively. Thus, the management unit 110 notifies the OSUs 200 of the value for priority wavelength. The management unit 110 may determine the value of priority wavelength based on the PON link information. For example, when PON link information for one OSU 200 indicates the number of registered ONU(s) 400 is becoming smaller, the management unit 110 determines increasing values for priority wavelength. The OSUs 200 set the value for priority wavelength into the wavelength notification signal.

The downlink control signal that is included in the wavelength notification signal is broadcasted to all of the ONUs 400.

When an unregistered ONU 400 determines that optical power of the downlink optical signal is larger than a set value (FIG. 4, S2), the signal reading unit 463 reads information indicating wavelength(s) and wavelength priorities in the wavelength notification signal (FIG. 4, S4). The wavelength(s) that the information indicates are a wavelength lambda 1 that the OSU 200-1 sets and a wavelength lambda 2 that the OSU 200-2 sets. The variable wavelength filter controller 467 sets a wavelength for the variable wavelength filter 479 based on the wavelength priorities, and notifies the variable wavelength filter 479 of the wavelength. The wavelength for the variable wavelength filter 479 is set based on the notice from the variable wavelength filter controller 467 (FIG. 4, S5). The wavelength for the variable wavelength filter 479 corresponds to the highest priority in the wavelength priorities. The unregistered ONU 400 performs the discovery sequence with the OSU 200 whose wavelength corresponds to the wavelength for the variable wavelength filter 479.

When the OSUs 200 perform the discovery sequence, each occasion of performing the discovery sequence for each OSU 200 may be improved smoothly. Thus, the number of the ONUs 400 that each OSU 200 manages may be improved on average.

Here, this optical network unit registration method is not limited to the example described above.

A discovery sequence between OSUs 200 and the ONU 400 may be performed. In this case, the OSU 200-1 and 200-2 work, and the OSU 200-1 and 200-2 perform a discovery sequence. When operations in this optical network unit registration method are same as the above-described optical network unit registration method, a detailed description will be omitted here.

When the OSUs 200 perform the discovery sequence, the wavelength notification signal includes more than two wavelengths that the ONU 400 sets one of them. The information indicates a wavelength lambda 1 for the OSU 200-1 and a wavelength lambda 2 for the OSU 200-2.

Further, the wavelength notification signal includes information that indicates transmission timing for a response request signal, for example, the discovery gate. The management unit 110 notifies of the transmission timing.

When an unregistered ONU 400 determines that optical power of the downlink optical signal is larger than a set value (FIG. 4, S2), the signal reading unit 463 reads information indicating wavelength(s) and transmission timing(s) for a response request signal in the wavelength notification signal (FIG. 4, S4). The wavelength(s) that the information indicates are a wavelength lambda 1 that the OSU 200-1 sets and a wavelength lambda 2 that the OSU 200-2 sets. The transmission timing(s) for a response request signal are transmission timing(s) that the OSU 200-1 transmits in the discovery gate and transmission timing that the OSU 200-2 transmits in the discovery gate.

The variable wavelength filter controller 467 sets a wavelength for the variable wavelength filter 479 based on the transmission timing(s). For example, the variable wavelength filter controller 467 sets a wavelength for the variable wavelength filter 479 that corresponds to a wavelength of the OSU 200 whose transmission timing is the earliest. After the setting for the wavelength for the variable wavelength filter 479, the variable wavelength filter controller 467 notifies the variable wavelength filter 479 of the wavelength. The wavelength for the variable wavelength filter 479 is set based on the notice from the variable wavelength filter controller 467 (FIG. 4, S5). The wavelength for the variable wavelength filter 479 corresponds to the highest value in the value for priority wavelength. The unregistered ONU 400 performs the discovery sequence with the OSU 200 whose wavelength corresponds to the wavelength for the variable wavelength filter 479.

When the OSUs 200 perform the discovery sequence, the unregistered ONU 400 recognizes, for example, the earliest transmission time that the OSU 200 transmits the discovery gate by the wavelength notification signal. Thus, the unregistered ONU 400 may start performing the discovery sequence immediately.

While the present invention has been particularly shown and described with reference to certain specific embodiments, it will be understood by those skilled in the art that the foregoing and other changes in form and details can be made therein without departing from the spirit and scope of the present invention.

What is claimed is:

1. An optical network unit registration method for registering an unregistered optical network unit in a network that includes an optical line terminal having a plurality of optical subscriber units that allocate a different wavelength one another, and a plurality of optical network units with a variable wavelength filter and configured to connect to the optical line terminal via one or more optical transmission paths, the optical network unit registration method comprising:
transmitting a wavelength notification signal that indicates a wavelength for the variable wavelength filter to one or more optical network units;
setting a transmission wavelength for the variable wavelength filter based on the wavelength that wavelength notification signal indicates; and
registering an unregistered optical network unit that receives the wavelength notification signal.

2. The optical network unit registration method according to claim 1, further comprising indicating, in the wavelength notification signal, more than two wavelengths for the variable wavelength filter.

3. The optical network unit registration method according to claim 2, further comprising:
indicating, in the wavelength notification signal, one or more wavelength priorities for the more than two wavelengths; and
setting the transmission wavelength for the variable wavelength filter based on the wavelength priorities.

4. The optical network unit registration method according to claim 2, further comprising including, in the wavelength notification signal, transmission timings for a response request signal that the optical subscriber units transmit.

5. The optical network unit registration method according to claim 1, further comprising indicating, in the wavelength notification signal, a wavelength for the variable wavelength filter that is different from a wavelength for the variable wavelength filter before the optical network unit receives the wavelength notification signal.

6. An optical network system comprising:
an optical line terminal including a plurality of optical subscriber units that allocate a different wavelength from one another;
a plurality of optical network units configured to connect to the optical line terminal via one or more optical transmission paths;
wherein an optical subscriber unit includes
a signal generation unit configured to generate a wavelength notification signal that notifies an optical network unit of a wavelength to set for transmission, and
an optical signal transmission unit configured to transmit a downlink optical signal that includes the wavelength notification signal to the optical network unit;
and wherein the optical network unit comprises
an optical signal reception unit with a variable wavelength filter configured to receive the downlink optical signal,
a signal reading unit configured to read the wavelength notification signal that is included in the downlink optical signal, and
a variable wavelength filter controller configured to notify the variable wavelength filter of a wavelength that is set as a transmission wavelength based on the wavelength notification signal.

7. The optical network system according to claim 6, wherein
each of the plurality of optical network units transmits an uplink optical signal having transmission timing different from another of the plurality of optical network units.
